(19) United States
(12) Patent Application Publication
(10) Pub. No.: US 2008/0059235 A1
(43) Pub. Date: Mar. 6, 2008

(54) Medical Information Storage and Access Device, and Method of Using the Same

(75) Inventor: John O. Boyd, Upper Arlington, OH (US)

Correspondence Address: LAFKAS PATENT LLC, PO Box 43289, CINCINNATI, OH, 45243-0289, US

(73) Assignee: CRITICAL MEDICAL INFORMATION, LLC, Upper Arlington, OH (US)

(21) Appl. No.: 11/464,305

(22) Filed: Aug. 14, 2006

(51) Int. Cl. G06F 19/00

(52) U.S. Cl. 705/3

(57) ABSTRACT

The present invention is a portable electronic copy of an individual's stored records and related documents that is remotely stored, secured, and accessible. The individual may modify the portable electronic copy of the individual's stored records and related documents at any time by way of the remotely stored and secured copy.

### FIELD OF THE INVENTION

The present invention relates generally to individuals' medical history records. More particularly, the present invention relates to a system and method of recording and accessing an individual's medical records and related treatment information to provide medical personnel an up-to-date medical history and related information about the individual.

### BACKGROUND

Most individuals in the United States and other industrialized nations see various physicians and others who create information related to the individual's healthcare and treatment. The information generated by these health professionals is generally not consolidated in any manner. Typically each physician, specialist, and/or emergency room doctor records patient information on their premises in their own format and systems. This information may be recorded in any of a number of different methods such as, for example, notes, diagnoses, lists of allergies, past and present medications, diagnostic readings and images, and the like.

Such medical history records are useful in reminding physicians and other medical specialists of previous diagnoses, drug interactions, allergies, and the like. As helpful as such medical records are, typically, such records are not easily accessed, due to physical separation of medical providers, office hours, holidays, etc., and differences in recording methods. These shortcomings can be life threatening in times of medical emergency and inconvenient and time consuming in other situations.

At the time of a medical emergency, quickly accessing medical records held by physicians and/or other specialists who have treated individual is virtually impossible. Most emergency room doctors do not have the time and/or abilities to track down these records of an individual brought into an emergency room, for example. Even obtaining basic medical and personal information from the patient in emergency situations is often difficult because of pain or shock being suffered by the patient. If the patient is unconscious it is impossible to obtain needed treatment information. As a result, emergency room doctors must rely on test, observation, and physical evidence to develop a treatment plan. This can result in undesired delays, unnecessary tests, increased expenses and potentially life threatening missteps.

Lack of information on an individual's wishes, i.e., advance directives, regarding treatment under certain conditions can also result in treatments the individual does not wish to have performed. Therefore, knowledge of an individual's advance directives can provide material assistance to medical service providers as they formulate a treatment plan.

To further compound the lack of quick access to an individual's medical history, new laws and regulations for privacy slow the process by which one typically can obtain an individual's medical records.

Thus, what is desired is a system and method of substantially immediate private access to up-to-date medical history and related information for an individual to provide safer and more effective medical care.

### SUMMARY

The various exemplary embodiments of the present invention includes a system for recording and accessing an individual's stored records, images and related documents, and creating advanced directives. The system is comprised of one or more portable storage devices having a connecting means, a memory means, and an interfacing and authenticating means. The system further includes a computer connected to the Internet and a substantially secure primary memory, wherein the primary memory saves the stored records and related documents and is accessible via the Internet. The memory means comprises stored records; created, stored, and downloaded from the primary memory. The one or more portable storage devices may be directly connected to the computer via the connecting means, such that the one or more portable storage devices connect to the primary memory whereby the portable storage devices are validated via the interfacing and authenticating means and the memory means of the one or more portable storage devices is accessed by the primary memory to permit downloading of stored records stored in primary memory to the memory means of the one or more portable storage devices.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a flowchart outlining an exemplary embodiment of the present invention.

FIG. 2 is another flowchart showing another exemplary embodiment of the present invention.

FIG. 3 is yet another flowchart showing another exemplary embodiment of the present invention.

### DETAILED DESCRIPTION

The various exemplary embodiments of the present invention include a system for recording and accessing an individual's medical history and related information.

Herein, stored records are defined to include any medical documentation, images, and the like from any related medical expert that are related to an individual's medical condition, whether in the past or present. The stored records and related documents may include personal contact information; emergency medical information; emergency medical contacts; emergency personal contacts, medical history; medical tests and lab results; medical and personal images including x-rays, and related images; living will; durable power of attorney for health care; organ donor; family medical information; business contact information; insurance information and contact; and combinations thereof.

The system of the various exemplary embodiments of the present invention includes one or more portable storage devices. The one or more portable storage devices are preferably retained on or near the individual's person. In a preferred embodiment, the one or more portable storage devices are a flash memory drive or other similar electronic or digital storage device, surrounded by a housing. Such device may be carried in a pocket, on a keychain, in a purse, etc.

The one or more portable storage devices comprise a connecting means, memory means, and an interfacing and authenticating means. The connecting means may be a universal USB outlet to connect to a universal USB inlet port on a computer. The memory means comprises the one or more drives or other similar storage of electronic and/or digital media, known now or future embodiments.

The interfacing and authenticating means of the one or more portable storage devices are initially activated by the individual using an associated unique customer serial number and/or other one or more identifiers provided at the time of purchase. The one or more portable storage devices may also include preprogrammed application software.

Upon initial insertion of the portable storage device into a computer via the connecting means, the interfacing and authenticating means connects to the immediate computer and then to the Internet connected to the immediate computer. Upon connection to the Internet, the interfacing and authenticating means connects to the primary memory of the system.

The primary memory is a remote electronic and/or digital storage of the individual's stored records. The primary memory may be in the form of a secure computer server or multiple servers. The primary memory may be password protected and secured such that only authorized persons may modify the content of the stored records of an individual, but authorized individuals with an appropriate password may have view only access to the stored records.

In the various exemplary embodiments, the content of the stored records associated with an individual may include, for example, personal contact information, emergency contact information, medical history, medical images, laboratory and test results, living will, durable power of attorney, organ donor information, family medical information, and business information.

The personal contact information is the individual's personal information including, for example, name, address, health insurance provider, and associated contact information.

The emergency medical information may include information relating to the individual's medications being taken, chronic conditions, allergic reactions, surgeries/implants, communicable diseases and other information that would help insure informed and focused medical treatment in the event of a medical emergency or routine medical treatment.

The emergency contact information may comprise a list of contact information on people the individual wishes to have contacted in the event of an emergency. This may include the emergency contact's relationship to the individual and information as to whether or not the emergency contact person possesses a copy of the individual's living will and if the emergency contact is named as Power of Attorney for Health Care. Further, the individual may designate a principal emergency contact person.

The medical history information may comprise full contact information for the individual's doctors, associated medical specialty, and information on illnesses and treatments received by the individual to date. The individual may also identify the primary care physician from among the doctors listed.

Preferably, the individual is also provided with a detailed questionnaire on conditions, diseases or treatments/surgeries they have received to complete the medical history information and which is incorporated into their medical history.

The medical images may comprise medical images in the form of, for example, X-rays, EKG, MRI, etc., can be stored for reference by physicians or other medical personnel.

The laboratory and test results may include any results from lab work and other medical test results including history for each. For example, this may include regular blood sugar test results for diabetic individuals.

In various exemplary embodiments, a living will may be included into the stored records. Such living will is comprised of interactive forms and instructions on creating a state specific living will for each of the fifty states and the District of Columbia. The living will that is created is stored in electronic format and is also printable for execution by the individual and witnesses/notary public, as needed. The individual may update the living will as needed, and living wills can be generated for specific states where the individual may be visiting or residing for any period of time.

In the various exemplary embodiments, a durable power of attorney for health care may be included in the stored records. Like the living will, it may comprise interactive forms and instructions on creating such a power of attorney for use in any of the fifty states and the District of Columbia. The power of attorney that is created is stored in electronic format and is also printable for execution by the individual and witnesses/notary public, as needed. The individual may update the power of attorney as needed, and power of attorneys can be generated for specific states where the individual may be visiting or residing for any period of time.

Any information regarding organ donation preferences of the individual may be indicated by the individual and saved in the stored records as well.

The individual also has the ability to create and save information of additional individuals, for example, children, parents, and/or spouse. This enables the individual to have access to necessary information relating to additional members in the case of an emergency involving one or more of these additional members.

In various exemplary embodiments, stored records may additionally include business information associated with the individual. Such business information may comprise, for example, record full business contact information associated with the individual's financial institutions, brokerages, life insurance companies, long term care insurers, disability insurers, health insurance, home insurance, car insurance, credit card providers, and the like. It also may provide a record the individual's wills and other important documents and where those documents are stored. The business information is preferably only viewable by the individual and persons inputting information into the primary means on behalf of and with the permission of the individual.

In various exemplary embodiments, the individual is also provided with a “wallet card.” The wallet card comprises contact information on the individual, instructions on how to access the portable storage device memory means and associated password, full contact information on the primary emergency contact person and instructions on how to access the view only portion of the individual's stored records on the primary memory.

After initial connection between the portable storage device and the primary memory, the primary memory downloads the content of the stored records for the individual to the one or more portable storage devices. Thus, the one or more portable storage devices preferably comprise substantially identical content of stored records of an individual as stored on the primary memory.

Preferably, in the various exemplary embodiments, as the primary memory is modified to update the individual's stored records, the modified content is downloaded and updated on the portable storage means through connection between the one or more portable storage devices and the primary memory.

In the various exemplary embodiments, it is preferred that the content of the stored records for an individual be password protected or otherwise secured to substantially ensure unauthorized access to the content of the stored records is not made. The contents of the stored records, on the one or more portable storage devices and/or the primary memory, may be secured in such a manner.

As the content of the records is secured, it is preferred that the content of the stored records for an individual is only modifiable by the individual and any third party to which the individual provides authorized access. Such third parties to which an individual may provide authorized access may include, for example, doctors, attorneys, spouse, family members, and the like.

The individual may modify the content of their stored records in the primary memory at any time by logging into the primary memory via the Internet. Upon logging into the primary memory, the individual is granted access only to his or her own stored records. Other individuals' stored records cannot be accessed without proper authorization.

In the various exemplary embodiments, upon modification of the primary memory on behalf of or by the individual that is not concurrently downloaded to the one or more portable storage devices, the primary memory sends an email notification to the individual confirming the changes, noting that the modifications have not yet been downloaded to the one or more portable storage devices, and urging the individual to download the modified contents of the stored records.

In a preferred embodiment, the one or more portable storage devices are authenticated and an encrypted key is loaded onto the portable storage device which substantially prohibits content of the stored records from the primary memory from being downloaded to a portable storage device other than the authenticated one or more portable storage devices. In other words, an individual may only download content of his own stored records to his own individual portable storage device.

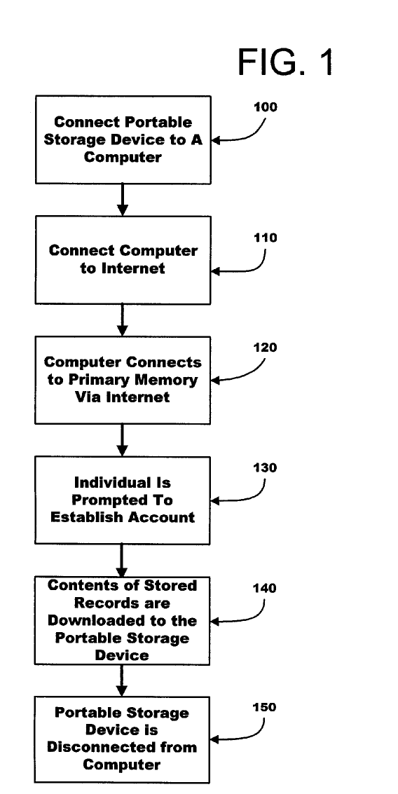

An exemplary embodiment of the present invention is outlined in FIG. 1. In this embodiment, a portable storage device has not yet initially been connected to the primary memory. The portable storage device is connected to a computer, preferably via a USB port or similar connecting means. See step 100. Upon connection to the computer, the computer connects to the Internet (step 110) to then connect to the primary memory (step 120). Preferably, upon connecting the one or more portable storage device to the computer, the connection to the Internet and subsequently to the primary memory is made automatically.

Upon connection to the primary memory, the individual is prompted to establish their account. See step 130. Establishing an account my include, for example, creating a unique username and password, upload associated documents, create living wills, create powers of attorney, etc.

Upon completion of the establishment of the individual's account, the contents of the stored records of the individual are downloaded via the Internet and computer to the portable storage device. See step 140. The portable storage device may then be disconnected from the computer (step 150) and carried on the individual's person.

The individual may reconnect to the primary memory as desired or needed in order to modify and edit the contents of the stored records. In order to reconnect, the individual is prompted to ensure proper authorization. Such prompting may come in the form of, for example, inputting a saved username and password, providing fingerprint authorization, or the like. Upon completion of the modification and editing of the contents of the stored records, the individual may download the modified and edited contents of the stored records to the portable storage device, thereby updating it.

In a preferred embodiment, the content of the stored records downloaded and saved on the portable storage device is “view only” and cannot be modified except via downloading modified content from the primary memory.

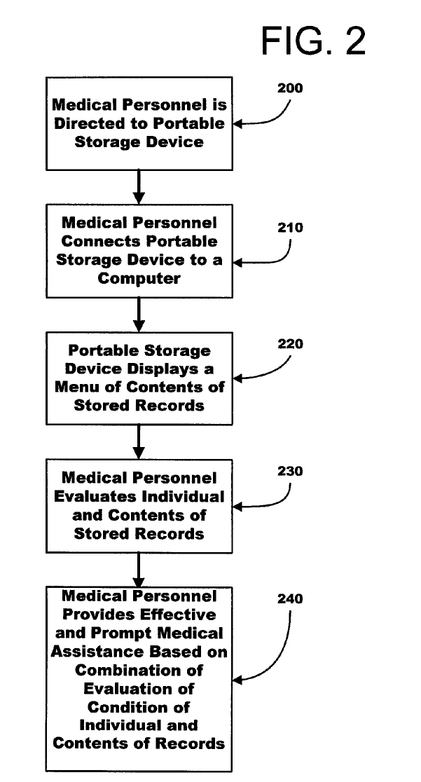

FIG. 2 is a flowchart representing an exemplary embodiment in which the portable storage device has already been initially connected to the primary memory. In the case of an emergency involving the individual, medical personnel or other emergency medical specialist may find the portable storage device on the individual or be directed to the portable storage device by the wallet card. See step 200. The medical personnel then connects the portable storage device to a computer, preferably via a USB port or similar connecting means. See step 210. Upon connection to the computer, the portable storage device automatically begins to display a menu of the contents of the stored records downloaded from the primary memory. See step 220. Based on the contents of the medical history in conjunction with the actual emergency situation and health of the individual being observed by the medical personnel (see step 230), a faster and more effective medical evaluation may be rendered. See step 240.

It is preferred that the medical personnel viewing the contents of the stored records of the individual can “view only” and not modify the contents of the stored records on the portable storage device.

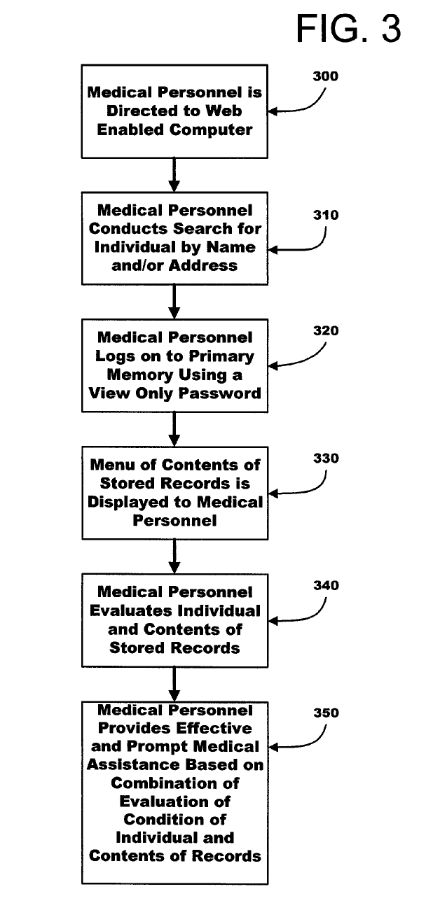

FIG. 3 is a flowchart representing another exemplary embodiment in which medical personnel or other emergency medical specialist does not have access to the portable storage device and accesses an individual's medical information on an Internet-enabled computer. See step 300. The medical personnel then conducts a search on the primary memory by searching by name and/or address of the individual requiring medical attention. See step 310. The medical personnel, upon locating the associated individual, logs onto the primary memory using a view only password. See step 320. A menu of the contents of the stored records is then displayed. See step 330. The medical personnel then evaluates the individual and the contents of the associated stored records. See step 340. Based on the contents of the medical history in conjunction with the actual emergency situation and health of the individual being observed by the medical personnel, prompt and more effective medical evaluation may be rendered. See step 350.

In various exemplary embodiments, upon connecting the portable storage device to the computer, the portable storage device may automatically connect to the primary memory via the Internet to provide instructions on how medical personnel can access the individual's stored records, preferably in a view only format, subject to the appropriate password being provided by the individual or, for example, the individual's primary emergency contact. Links to related health care information sites and other information may also be provided.

In various exemplary embodiments, if the portable storage device is not available, medical personnel can access the individual's stored records, preferably in a view only format, via the Internet utilizing information obtained from the individual and/or their associated wallet card, subject to the appropriate password being provided by the individual or, for example, the individual's primary emergency contact. Links to related health care information sites and other information may also be provided.

An individual may possess multiple storage devices according to the embodiments of the present invention. This would allow an individual to keep such storage devices wherever convenient, for example, on a key ring, in a purse, on a golf bag, in vehicle's glove box, etc. Each such storage device owned by an individual would need to be individually updated from the primary memory.

However, it is preferred wherein an individual possesses multiple storage devices, at least one of the multiple storage devices is a master storage device that is enabled to automatically link to the primary memory when connected to an Internet-enabled computer.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A system for recording and accessing an individual's stored records, images and related documents, and creating advanced directives the system comprising:
one or more portable storage devices, wherein the one or more devices comprise a connecting means, a memory means, and an interfacing and authenticating means;
a computer connected to the Internet; and
a substantially secure primary memory, wherein the primary memory saves the stored records and related documents and is accessible via the Internet;
wherein the memory means comprises stored records created, stored, and downloaded from the primary memory, and wherein the one or more portable storage devices may be directly connected to the computer via the connecting means, such that the one or more portable storage devices connect to the primary memory whereby the one or more portable storage devices are validated via the interfacing and authenticating means and the memory means of the one or more portable storage devices is accessed by the primary memory to permit downloading of stored records stored in primary memory to the memory means of the one or more portable storage devices.

2. The system according to claim 1, wherein the one or more portable storage devices are comprised of a portable flash memory drive and housing.

3. The system according to claim 1, wherein the connecting means is a USB outlet for connecting to a USB port on the computer.

4. The system according to claim 1, wherein the interfacing and authenticating means automatically connects the portable storage device to the primary memory upon connection to the computer.

5. The system according to claim 1, wherein the one or more portable storage devices are password protected.

6. The system according to claim 1, wherein the one or more portable storage devices are authenticated and an encrypted key is loaded onto the one or more portable storage devices which substantially prohibits content of the stored records from the primary memory from being downloaded to a portable storage device other than the authenticated portable storage devices.

7. The system according to claim 1, wherein upon interfacing and authenticating between the portable storage device and the primary memory, the one or more portable storage devices download and synchronize updated stored records and related documents associated with the individual, such that the one or more portable storage devices and primary memory comprise the substantially identical stored records and related documents for the individual.

8. The system according to claim 1, wherein the primary memory is one or more electronic or digital storage computers or computer servers connected to the Internet.

9. The system according to claim 1, wherein the stored records and related documents for the individual may not be altered by directly accessing the one or more portable storage devices independently of the primary memory.

10. The system according to claim 1, wherein the stored records and related documents for the individual may not be altered via interfacing with the primary memory in the utilizing a “view only” password provided to medical and other authorized personnel.

11. The system according to claim 1, wherein the stored records and related documents are selected from the group consisting of personal contact information;
emergency medical information; emergency medical contacts; emergency personal contacts, medical history; medical tests and lab results; medical and personal images including x-rays, and related images; living will; durable power of attorney for health care; organ donor; family medical information; business contact information; insurance information and contact; and combinations thereof.

12. The system according to claim 1, wherein the contents of the stored records on the one or more portable storage devices can be viewed and/or printed without need for connection to computer connected to the Internet.

13. The system according to claim 1, further comprising a identification and instruction card indicating the name of the individual, primary emergency contact and how medical and other authorized personnel can access the one or more portable storage devices and/or the primary memory of the system.

14. A method of recording and accessing an individual's stored records, comprising:
connecting one or more portable storage devices to a computer, wherein the one or more devices comprise a connecting means, a memory means, and an interfacing and authenticating means; and
viewing the stored records of the individual on the computer;
wherein the memory means comprises stored records created, stored, and downloaded from a primary memory via the Internet, and wherein the one or more portable storage devices may be directly connected to the computer via the connecting means, such that the one or more portable storage devices connect to the primary memory whereby the one or more portable storage devices are validated via the interfacing and authenticating means and the memory means of the one or more portable storage devices is accessed by the primary memory to permit downloading of stored records stored in primary memory to the memory means of the one or more portable storage devices.

15. The method according to claim 14, wherein upon interfacing and authenticating between the one or more portable storage devices and the primary memory, the one or more portable storage devices download and synchronize updated stored records and related documents associated with the individual, such that the one or more portable storage devices and primary memory comprise the substantially identical stored records and related documents for the individual.

16. The method according to claim 14, wherein the one or more portable storage devices are comprised of a portable flash memory drive and housing.

17. The method according to claim 14, wherein upon connecting the one or more portable storage devices to a computer, the computer may connect to a substantially secure primary memory via the Internet, wherein the primary memory stores the stored records and related documents of the individual which can be modified and edited by the individual upon proper authorization and authentication.

18. A system for recording and accessing an individual's stored records, images, and related documents, and creating advanced directives the system comprising:
a computer connected to the Internet;
a substantially secure primary memory, wherein the primary memory saves the stored records and related documents and is accessible via the Internet; and
a medical personnel view only password for accessing the primary memory;
wherein the primary memory comprises the individual's stored records, images, and related documents, such that medical personnel may access the primary memory remotely by inputting the medical personnel read-only password to search for stored records relating to an individual needing medical assistance, and then view the stored records in a read-only display.
